(19) United States
(12) Patent Application Publication
(10) Pub. No.: US 2021/0189204 A1
(43) Pub. Date: Jun. 24, 2021

(54) ADHESIVE, HEAT-SENSITIVE SCREEN MASTER, AND METHOD FOR PRODUCING HEAT-SENSITIVE SCREEN MASTER

(71) Applicant: RISO KAGAKU CORPORATION, Tokyo (JP)

(72) Inventors: Hirotaka TOMINAGA, Ibaraki (JP); Tomoko TERANAKA, Ibaraki (JP); Masahiro IWAMOTO, Ibaraki (JP)

(21) Appl. No.: 17/129,017

(22) Filed: Dec. 21, 2020

(30) Foreign Application Priority Data
Dec. 24, 2019 (JP) 2019-232530

(51) Int. Cl. C09J 175/04; B32B 5/02; B32B 7/12; B32B 27/12; B41F 15/34; B41C 1/14

(52) U.S. Cl. CPC C09J 175/04; B32B 5/028; B41C 1/145; B32B 27/12; B41F 15/34; B32B 7/12

(57) ABSTRACT

An adhesive containing at least one selected from the group consisting of a urethane prepolymer and a polyol, a polyisocyanate, a polymerizable (meth)acrylate compound, and a photopolymerization initiator is disclosed. A heat-sensitive screen master and a method for producing a heat-sensitive screen master are also disclosed.

### CROSS REFERENCE TO RELATED APPLICATIONS

This application is based upon and claims the benefit of priority from the prior Japanese Patent Application No. 2019-232530, filed on Dec. 24, 2019, the entire contents of which are incorporated by reference herein.

### BACKGROUND OF THE INVENTION

### Field of the Invention

Embodiments of the present invention relate to an adhesive, a heat-sensitive screen master, and a method for producing a heat-sensitive screen master.

### Description of the Related Art

A platemaking method for producing a plate for stencil printing (for example, screen printing), in which a thermoplastic resin film of a heat-sensitive stencil master including the thermoplastic resin film and a porous support bonded together is perforated by performing selective heating and melting with a thermal head, thereby forming perforated portions corresponding with an image, is known as thermal platemaking. As the heat-sensitive stencil master, for example, a heat-sensitive screen master in which a screen printing mesh is used as the porous support may be used.

JP 2010-214635 A discloses a stencil paper for screen printing, which is obtained by bonding a thermoplastic synthetic resin film and a screen printing mesh using an adhesive in which a main agent containing a polyurethane, and a curing agent containing tolylene diisocyanate and a urethane resin are combined.

JP 2018-165002 A discloses a heat-sensitive screen master, which is obtained by bonding a screen printing mesh and a thermoplastic resin film, and discloses an ultraviolet curable type adhesive as an examples of an adhesive.

### SUMMARY

An embodiment of the present invention relates to an adhesive containing at least one selected from the group consisting of a urethane prepolymer and a polyol, a polyisocyanate, a polymerizable (meth)acrylate compound, and a photopolymerization initiator.

Another embodiment of the present invention relates to a method for producing a heat-sensitive screen master, the method including irradiating a layered body including a screen printing mesh, an adhesive layer including the adhesive described above, and a thermoplastic resin film in this order, with active energy rays.

Another embodiment of the present invention relates to a heat-sensitive screen master that includes a screen printing mesh, a layer formed using the adhesive described above, and a thermoplastic resin film.

### DETAILED DESCRIPTION OF THE EMBODIMENTS

Embodiments of the present invention are described below in detail, but the present invention is of course not limited to these embodiments, and various modifications and alterations may be applied.

### <Adhesive>

An adhesive according to one embodiment contains at least one selected from the group consisting of a urethane prepolymer and a polyol (hereinafter sometimes referred to as “the component A”), a polyisocyanate (hereinafter sometimes referred to as “the component B”), a polymerizable (meth)acrylate compound (hereinafter sometimes referred to as “the component C”), and a photopolymerization initiator (hereinafter sometimes referred to as “the component D”).

In general, urethane-based adhesives may be cured by application of heat, moisture and/or the like. Urethane-based adhesives tend to be capable of exhibiting good adhesive strength, but generally tend to require a relatively long time for curing. In those cases in which an article such as a heat-sensitive screen master is manufactured using such an adhesive, and in which a layered body in which two layers are bonded together by using the adhesive is produced, and, before the adhesive is cured, the layered body is transported on a manufacturing apparatus such as a laminator in a state in which the viscosity of the adhesive is low, then wrinkles due to the manufacturing apparatus such as a laminator may be generated on the surface of the obtained article, which may be one factor of a decrease in the yield.

Ultraviolet curable adhesives tend to be capable of being cured in a relatively short time by irradiation with ultraviolet rays. On the other hand, in those cases where only an ultraviolet curable adhesive is used as the adhesive, the adhesive may sometimes become too hard, so that the adhesion between the upper layer and the lower layer may sometimes be lowered, and the adhesive strength may sometimes be lowered.

The adhesive of this embodiment contains at least one (component A) selected from the group consisting of a urethane prepolymer and a polyol, and a polyisocyanate (component B), and further contains a polymerizable (meth)acrylate compound (component C) and a photopolymerization initiator (component D). By containing the component C and the component D, polymerization of the component C can be initiated by radicals generated from the component D by active energy rays such as ultraviolet rays, and the component C can be cured. Therefore, after the application of the adhesive, the component C may be first cured by irradiation with active energy rays such as ultraviolet rays to increase the viscosity of the adhesive, whereby the generation of wrinkles on the surface of an article on a manufacturing apparatus such as a laminator may be reduced. Further, because the adhesive contains components A and B, excellent adhesive strength can be obtained by curing the adhesive in an environment with heat and moisture.

The use of this adhesive is not particularly limited, but it can be preferably used, for example, as an adhesive for a heat-sensitive screen master.

The adhesive may contain, as the component A, a urethane prepolymer, a polyol, or a combination of a urethane prepolymer and a polyol.

A material that is compatible with the component B may be preferably used as the component A. The component A is preferably a liquid at 23° C.

The urethane prepolymer can be obtained by reaction of a polyol component and an isocyanate component. The urethane prepolymer may contain, as a terminal functional group, a hydroxyl group (—OH), an isocyanate group (—NCO), or both of these groups.

It is preferable that the urethane prepolymer does not contain a (meth)acryloyl group.

The urethane prepolymer is preferably a liquid at 23° C.

The weight average molecular weight of the urethane prepolymer is not particularly limited, but is preferably from 2,000 to 10,000, and more preferably from 3,000 to 8,000. The weight average molecular weight of the urethane prepolymer is a polystyrene equivalent value determined by gel permeation chromatography (GPC).

The viscosity of the urethane prepolymer at 25° C. and at a shear rate of 500/s is preferably not more than 200,000 mPa s. The viscosity of the urethane prepolymer at 25° C. and at a shear rate of 500/s is more preferably not more than 100,000 mPa-s, and even more preferably 80,000 mPa s or less. Although there are no particular limitations on the lower limit of the viscosity provided the urethane prepolymer is in a liquid state, the viscosity of the urethane prepolymer at 25° C. and at the shear rate of 500/s may be, for example, at least 5,000 mPa s.

Examples of commercially available products for the urethane prepolymer include “TAKELAC A-666” and “TAKELAC A-695” (both product names) manufactured by Mitsui Chemicals, Inc.

A single urethane prepolymer may be used alone, or a combination of two or more urethane prepolymers may be used.

The polyol is preferably a liquid at 23° C.

There are no particular limitations on the polyol, and any polyol having two or more hydroxyl groups may be used. The polyol preferably has a hydroxyl group at each of both terminals.

For example, the types of polyols typically used as raw materials for polyurethane resin may be used as the polyol.

Examples of the polyol include a polyester polyol, a polyether polyol, a polycarbonate polyol, a polyacetal polyol, a polyacrylate polyol, a polyesteramide polyol, a polythioether polyol, and a polyolefin polyol such as polybutadiene polyol. Preferable examples of the polyol include those having hydroxyl group at each of both terminals such as a polyether polyol, a polyester polyol, and a polycarbonate polyol, having a hydroxyl group at each of both terminals.

It is preferable that the polyol does not contain a (meth)acryloyl group.

Examples of commercially available products for the polyol include EXCENOL 750ED (a polyether polyol) manufactured by AGC Group, ADEKA NEW ACE #50 (a polyester polyol) manufactured by ADEKA Corporation, and DURANOL G3452 (a polycarbonate polyol) manufactured by Asahi Kasei Corporation.

A single polyol may be used alone, or a combination of two or more polyols may be used.

From the viewpoint of improving the adhesive strength, the amount of the component A relative to the total mass of the adhesive is preferably at least 5% by mass, and more preferably 10% by mass or greater. From the viewpoint of improving the adhesive strength, the amount of the component A relative to the total mass of the adhesive may be, for example, 30% by mass or greater or 50% by mass or greater.

On the other hand, the amount of the component A relative to the total mass of the adhesive is preferably not more than 80% by mass, more preferably not more than 60% by mass, even more preferably not more than 40% by mass, and still more preferably 30% by mass or less.

For example, the amount of the component A relative to the total mass of the adhesive is preferably from 5 to 80% by mass, more preferably from 5 to 60% by mass, even more preferably from 10 to 40% by mass, and still more preferably from 10 to 30% by mass.

In those cases where the adhesive contains a solvent described below, the amount of the component A may be, for example, within the numerical range described above relative to the total mass of the adhesive. The amount of the component A may be, for example, within the numerical range described above relative to the mass obtained by subtracting the mass of the solvent from the total mass of the adhesive.

From the viewpoint of improving the adhesive strength, the amount of the component A relative to the total mass of the component A and the component B is preferably at least 5% by mass, and is more preferably 10% by mass or greater. From the viewpoint of improving the adhesive strength, the amount of the component A relative to the total mass of the component A and the component B may be, for example, 40% by mass or greater or 60% by mass or greater.

The adhesive may contain a polyisocyanate as the component B.

There are no particular limitations on the polyisocyanate, and any polyisocyanate having two or more isocyanate groups may be used as the polyisocianate. The polyisocianate preferably has an isocyanate group at a terminal. A polyisocyanate compatible with the component A may be used as the polyisocyanate. The polyisocyanate is preferably a liquid at 23° C.

The polyisocyanate may be, for example, an aliphatic polyisocyanate, an alicyclic polyisocyanate or an aromatic polyisocyanate or the like.

Specific examples of the polyisocyanate include diisocyanates such as hexamethylene diisocyanate (1,6-diisocyanate hexane) (HDI), 1,3-bis (isocyanatomethyl)benzene, 1,3-bis(isocyanatomethyl)cyclohexane, 1,5-naphthalene diisocyanate, diphenylmethane-4,4-diisocyanate, meta-xylene diisocyanate, 4,4′-methylenebis(phenylene isocyanate) (MDI), and tolylene diisocyanate (TD); triisocyanates such as 1-methylbenzene-2,4,6-triyl triisocyanate and 1,6,11-triisocyanate undecane; and polymethylene polyphenyl polyisocyanates; as well as modified products of these polyisocyanates.

For example, in those cases where printing is performed using a solvent ink (solvent-based ink) which contains a volatile organic solvent as the main solvent, and also using a plate obtained by subjecting a master to the plate-making, the solvent of the residual solvent ink left on the plate after printing may tend to evaporate, making it more likely for the solid fraction to remain in the form of aggregates. If such aggregates left on the plate after printing is wiped with a solvent, then the adhesive that bonds together the thermoplastic resin film and the screen printing mesh can sometimes dissolve, which may cause the thermoplastic synthetic resin film to detach from the screen printing mesh. In order to repeatedly use the plate produced by subjecting a master to platemaking, it is desirable that the adhesive is poorly soluble in the solvent used for wiping. Therefore, from the viewpoint of improving the solvent resistance of the adhesive, a modified product of a polyisocyanate is more preferable as the polyisocyanate. Examples of the modified products of a polyisocyanate include an isocyanurate-modified product of a polyisocyanate, a biuret-modified product of a polyisocyanate, an allophanate-modified product of a polyisocyanate, and an oxadiazinetrione modified product of a polyisocyanate. In some embodiments, from the viewpoint of improving solvent resistance, the modified product of a polyisocyanate is preferably an isocyanurate-modified product of a polyisocyanate and/or a biuret-modified product of a polyisocyanate, and is more preferably an isocyanurate-modified product of a polyisocyanate.

Because isocyanurate-modified products of a polyisocyanate may exhibit a low degree of freedom of rotation of the N—C bond, they are more likely to form a hard coating film, and are therefore more likely to resistant to solvent permeation.

From the viewpoint of improving the solvent resistance, the modified product of a polyisocyanate is preferably a modified product of an aliphatic polyisocyanate, is more preferably a modified product of an aliphatic diisocyanate, and is even more preferably a modified product of hexamethylene diisocyanate. In some embodiments, for example, the modified product of hexamethylene diisocyanate is preferably an isocyanurate-modified product of hexamethylene diisocyanate and/or a biuret-modified product of hexamethylene diisocyanate, and, from the viewpoint of improving solvent resistance, the modified product of hexamethylene diisocyanate is more preferably an isocyanurate-modified product of hexamethylene diisocyanate.

Examples of commercially available products for the polyisocyanate include DURANATE TPA-100 (an isocyanurate-modified product of hexamethylene diisocyanate) and DURANATE 24A-100 (a biuret-modified product of hexamethylene diisocyanate) manufactured by Asahi Kasei Corporation, and LUPRANATE MI (4,4′-methylenebis(phenylene isocyanate)) and LUPRANATE TDI (tolylene diisocyanate) manufactured by BASF INOAC Polyurethanes Ltd.

A single polyisocyanate may be used alone, or a combination of two or more polyisocyanates may be used.

From the viewpoint of improving the crosslinking density by the reaction between isocyanate groups and thereby improving the solvent resistance, and/or the viewpoint of improving the compatibility of component B with component C, whereby the adhesive viscosity can be efficiently increased upon irradiation with ultraviolet rays to further reduce the generation of wrinkles on the surface of an article obtained using the adhesive, the amount of the component B relative to the total mass of the adhesive is preferably at least 10% by mass, more preferably at least 30% by mass, even more preferably at least 40% by mass, still more preferably at least 50% by mass, and further preferably 60% by mass or greater.

On the other hand, the amount of the component B relative to the total mass of the adhesive is preferably not more than 90% by mass, and is more preferably 85% by mass or less.

For example, the amount of component B relative to the total mass of the adhesive is preferably from 10 to 90% by mass, more preferably from 30 to 90% by mass, even more preferably from 40 to 90% by mass, still more preferably from 50 to 85% by mass, and further preferably from 60 to 85% by mass.

In those cases where the adhesive contains a solvent described below, the amount of the component B may be, for example, within the numerical range described above relative to the total mass of the adhesive. The amount of the component B may be, for example, within the numerical range described above relative to the mass obtained by subtracting the mass of the solvent from the total mass of the adhesive.

From the viewpoint of improving the solvent resistance and/or the viewpoint of further reducing the generation of wrinkles, the amount of the component B relative to the total mass of the component A and the component B is preferably at least 10% by mass, more preferably at least 30% by mass, even more preferably at least 65% by mass, and still more preferably 70% by mass or greater.

When the ratio of the component B to the total amount of the component A and the component B is increased, since the component B and the component C have a relatively high compatibility with each other, the viscosity of the adhesive can be efficiently increased upon irradiation with ultraviolet rays, and thus the generation of wrinkles tends to be more effectively reduced. When the amount of component C is reduced, the amounts of component A and component B can be increased, whereby the adhesive strength and the solvent resistance may be further improved.

The mass ratio (A:B) between the component A and the component B is preferably within a range from 90:10 to 5:95. The mass ratio (A:B) between the component A and the component B is more preferably within a range from 70:30 to 5:95, even more preferably within a range from 35:65 to 5:95, and still more preferably within a range from 30:70 to 10:90, from the viewpoint of improving the solvent resistance and/or the viewpoint of further reducing the generation of wrinkles on the surface of an article obtained using an adhesive. The mass ratio (A:B) between the component A and component B may be, for example, from 80:20 to 36:64, or from 80:20 to 40:60.

The adhesive may contain a polymerizable (meth)acrylate compound as the component C.

As the polymerizable (meth)acrylate compound, one having one or more (meth)acryloyl groups may be used. The polymerizable (meth)acrylate compound is preferably a polyfunctional compound having two or more (meth)acryloyl groups in one molecule.

As the polymerizable (meth)acrylate compound, for example, a (meth)acrylate monomer, a (meth)acrylate oligomer, or both of them may be used. The term “(meth)acrylate” means methacrylate, acrylate or both of them. The term (meth)acryloyl group means an acryloyl group, a methacryloyl group, or both of them.

Examples of monofunctional (meth)acrylate monomers include 2-hydroxypropyl acrylate, phenol EO-modified acrylate (“EO-modified” means ethylene oxide-modified), dicyclopentenyl oxyethyl acrylate, isobornyl acrylate, phenol ethylene oxide-modified acrylate, and fluorene diacrylate. Examples of multifunctional (meth)acrylate monomers include polyethylene glycol diacrylate, tripropylene glycol diacrylate, 1,9-nonanediol diacrylate, 1,6-hexanediol diacrylate, bisphenol A diglycidyl ether diacrylate, tetraethylene glycol diacrylate, trimethylolpropane triacrylate, pentaerythritol triacrylate, pentaerythritol tetraacrylate, dipentaerythritol hexaacrylate, N-(acryloyloxyethyl)hexahydrophthalimide, dimethyloldicyclopentane diacrylate, and isocyanuric acid EO-modified diacrylate.

Examples of commercially available products for the (meth)acrylate monomer include, for example, “LIGHT ESTER HOP-A (N)” (product name) manufactured by Kyoeisha Chemical Co., Ltd., ARONIX M-102 and ARONIX M-350 (both product names) manufactured by Toagosei Co., Ltd., and NK ESTER A-200 and NK ESTER A-DPH manufactured by Shin-nakamura Chemical Co., Ltd. (both product names).

Examples of the (meth)acrylate oligomer include urethane (meth)acrylate, epoxy (meth)acrylate, and polyester (meth)acrylate.

The urethane (meth)acrylate contains a (meth)acryloyl group and a urethane bond.

Examples of the urethane (meth)acrylate include a phenyl glycidyl ether acrylate hexamethylene diisocyanate urethane prepolymer, a pentaerythritol triacrylate hexamethylene diisocyanate urethane prepolymer, a pentaerythritol triacrylate toluene diisocyanate urethane prepolymer, a pentaerythritol triacrylate isophorone diisocyanate urethane prepolymer, and a dipentaerythritol pentaacrylate hexamethylene diisocyanate urethane prepolymer.

Examples of commercially available products for the urethane (meth)acrylate include AH-600, UA-306H, UA-306T, UA-306I, and UA-510H (all product names) manufactured by Kyoeisha Chemical Co., Ltd.

As the epoxy (meth)acrylate, a compound containing a structure obtained by reacting a carboxyl group of acrylic acid or methacrylic acid with an epoxy group of a compound having an epoxy group may be used.

Examples of commercially available products for epoxy (meth)acrylate include “EPOXY ESTER 80 MFA” (product name) manufactured by Kyoeisha Chemical Co., Ltd.

Examples of commercially available products for polyester (meth)acrylate include ALONIX M-7100 and ALONIX M-6100 (both product names) manufactured by TOAGOSEI CO., LTD.

With respect to these polymerizable (meth)acrylate compounds, a single polymerizable (meth)acrylate compound may be used alone, or a combination of two or more (meth)acrylate compounds may be used.

From the viewpoint of further reducing the generation of wrinkles on the surface of an article obtained using the adhesive, and/or from the viewpoint of increasing the viscosity of the adhesive by curing the component C, thereby reducing the generation of deviation between the upper layer and the lower layer sandwiching the adhesive to further improve the adhesive strength, the amount of the component C relative to the total mass of the adhesive is preferably at least 1% by mass, more preferably at least 3% by mass, and even more preferably 6% by mass or greater.

On the other hand, from the viewpoint of further improving the adhesive strength, the amount of the component C relative to the total mass of the adhesive is preferably not more than 40% by mass, more preferably not more than 30% by mass, and even more preferably 15% by mass or less.

The amount of the component C relative to the total mass of the adhesive is, for example, preferably from 1 to 40% by mass, more preferably from 1 to 30% by mass, even more preferably from 3 to 30% by mass, still more preferably from 6 to 30% by mass, and still more preferably from 6 to 15% by mass.

The adhesive may contain a photopolymerization initiator as the component D.

The photopolymerization initiator is not particularly limited as long as it generates radicals by irradiation with active energy rays such as ultraviolet rays to initiate the polymerization reaction of the component C.

Examples of the photopolymerization initiator include an acylphosphine oxide-based compound, a thioxanthone-based compound, an acetophenone-based compound, and a benzophenone-based compound.

Examples of the acylphosphine oxide-based compound include bis(2,4,6-trimethylbenzoyl)-phenylphosphine oxide, 2,4,6-trimethylbenzoyl-diphenyl-phosphine oxide, ethyl(2,4,6-trimethylbenzoyl)phenylphosphinate, and bis(2,6-dimethoxybenzoyl)-2,4,4-trimethylpentylphosphine oxide.

Examples of the thioxanthone-based compound include thioxanthone, 2-chlorothioxanthone, 2,4-diethylthioxanthone, isopropylthioxanthone, 1-chloro-4 propylthioxanthone, 3-[3,4-dimethyl-9-oxo-9H-thioxanthone-2-yl-oxy]-2-hydroxypropyl-N, N, N-trimethylammonium chloride, and fluorothioxanthone.

Examples of the acetophenone-based compound include 2,2-dimethoxy-1,2-diphenylethane-1-one, 1-hydroxycyclohexyl phenyl ketone, 2-hydroxy-2-methyl-1-phenylpropane-1-one, 1-[4-(2-hydroxyethoxy)phenyl]-2 hydroxy-2-methyl-1-propane-1-one, 2-methyl-1-[4-(methylthio)phenyl]-2-morpholinopropane-1-one, 2-benzyl-2-dimethylamino-1-(4-morpholinophenyl)butane-1-one, diethoxyacetophenone, oligo{2-hydroxy-2-methyl-1-[4-(1-methylvinyl)phenyl]propanone}, 2-hydroxy-1-{4-[4-(2-hydroxy-2-methylpropionyl)benzyl]phenyl}-2-methylpropane-1-one, and 2-(dimethylamino)-2-[(4-methylphenyl)methyl]-1-[4-(4-morpholinyl)phenyl]-butanone.

Examples of the benzophenone-based compound include benzophenone, 4-phenylbenzophenone, methyl-o-benzoylbenzoate, 2,4,6-trimethylbenzophenone, 4-benzoyl-4′-methyldiphenylsulfide, and 1-[4-(4-benzoylphenyl)thio]phenyl]-2-methyl-2-[(4-methylphenyl)sulfonyl]-1-propanone.

With respect to these photopolymerization initiators, a single photopolymerization initiator may be used alone or a combination of two or more photopolymerization initiator may be used.

The amount of the component D relative to the total mass of the component C and the component D is preferably at least 0.1% by mass, and more preferably 1% by mass or greater. On the other hand, the amount of component D relative to the total mass of the component C and the component D is preferably not more than 10% by mass, and more preferably 5% by mass or less. For example, the amount of the component D relative to the total mass of the component C and the component D is preferably from 0.1 to 10% by mass, and more preferably from 1 to 5% by mass.

For example, the amount of the component D relative to the total mass of the adhesive is preferably from 0.05 to 5% by mass, and more preferably from 0.1 to 2% by mass.

The adhesive may contain, for example, a solvent as a diluent. An organic solvent is preferred as the solvent.

The adhesive may optionally contain one or more additives. Examples of the additives include an antistatic agent, a lubricants, a tackifier, a filler, a leveling agent, and a coloring agent.

The adhesive may be, for example, a one-part adhesive, a two-part adhesive, a three-part adhesive, or the like. For example, the component A and the component B may be stored separately, and the component A and the component B may be mixed at the time of use. In this case, other components besides the component A and the component B may be stored together with the component A and/or the component B. For example, the component A, the component B and the components C and D may be stored separately and may be mixed at the time of use. In this case, components other than the component A, the component B, the component C and the component D may be stored together with any of these components.

### <Heat-Sensitive Screen Master>

The heat-sensitive screen master of one embodiment includes a screen printing mesh, a layer formed using the adhesive described above, and a thermoplastic resin film.

The heat-sensitive screen master is preferably a heat-sensitive screen master in which a screen printing mesh and a thermoplastic resin film are bonded together using the adhesive described above. The heat-sensitive screen master preferably includes, for example, a screen printing mesh, a layer formed using the adhesive, and a thermoplastic resin film in this order. It is preferable that, in the heat-sensitive screen master, the screen printing mesh and the layer formed using the adhesive are in contact with each other, and the layer formed using the adhesive and the thermoplastic resin film are in contact with each other.

The screen printing mesh may be any screen printing mesh that undergoes substantially no perforation upon heating with a thermal head, and enables ink to pass through the screen printing mesh during printing, and, for example, meshes produced from fibers of, for example, polyester, nylon, rayon, stainless steel, silk, or cotton or the like may be used.

The thickness of the screen printing mesh may be typically from 40 to 270 μm, and is preferably from 50 to 150 μm.

The mesh count (the number of fibers per one inch) of the screen printing mesh may be typically from 40 to 500 (mesh), and is preferably from 50 to 350 (mesh). The mesh counts in the longitudinal direction and the transverse direction may be the same or different, provided that they each fall within the above mesh count range.

Examples of the thermoplastic resin film that may be used include a polyethylene-based resin film, a polypropylene-based resin film, a polyester-based resin film, a polyamide-based resin film, a polyvinyl chloride-based resin film, and a polyvinylidene chloride-based resin film. Among these, examples of the thermoplastic resin film that may be preferably used include a polyester-based resin film. Examples of the polyester-based resin include polyethylene terephthalate, polyethylene-2,6-naphthalate, polybutylene terephthalate, an ethylene terephthalate/ethylene isophthalate copolymer, a butylene terephthalate/ethylene terephthalate copolymer, a butylene terephthalate/hexamethylene terephthalate copolymer, a hexamethylene terephthalate/1,4-cyclohexane dimethylene terephthalate copolymer, and an ethylene terephthalate/ethylene-2,6-naphthalate copolymer. The thermoplastic resin film may optionally contain one or more additives. Examples of the additive include a pigment, a viscosity modifier, a dispersant, a dye, a lubricant, a crosslinking agent, and a plasticizer.

The thickness of the thermoplastic resin film may be any thickness that enables thermal digital screen platemaking, but may be typically from 0.5 to 10 μm, and is preferably from 1 to 5 μm.

The thermoplastic resin film preferably exhibits shrinkage properties that are suitable for facilitating melt perforation by thermal digital screen platemaking, and may be a uniaxially or biaxially stretched film as appropriate.

The heat-sensitive screen master may include one or more other layers. For example, an overcoat layer may be provided on the side where the thermoplastic resin film comes into contact with the thermal head in order to prevent fusion of the thermoplastic resin film to the thermal head or to reduce friction between the thermal head and the thermoplastic resin film.

The method for producing the heat-sensitive screen master is not particularly limited.

The heat-sensitive screen master can be manufactured, for example, by a method including irradiating a layered body (hereinafter, sometimes referred to as “the layered body L”) including a screen printing mesh, an adhesive layer containing the adhesive as described above, and a thermoplastic resin film in this order, with active energy rays (hereinafter, sometimes referred to as “the active energy ray irradiation step”).

The adhesive layer included in the layered body L is a layer containing the adhesive as described above and can be obtained using the adhesive as described above. For example, the adhesive layer can be formed by applying the adhesive between the screen printing mesh and the thermoplastic resin film.

The layered body L can be manufactured, for example, by a method including applying the adhesive between the screen printing mesh and the thermoplastic resin film. The screen printing mesh, the adhesive layer containing the adhesive, and the thermoplastic resin film can be arranged in this order by the step of applying the adhesive between the screen printing mesh and the thermoplastic resin film. The layered body L may include one or more other layers.

The components of the adhesive may be mixed in advance. The components of the adhesive may be mixed immediately prior to use.

There are no particular limitations on the method used for applying the adhesive between the screen printing mesh and the thermoplastic resin film. Specifically, for example, the adhesive may be applied using a roll coater or the like, and the screen printing mesh and the thermoplastic resin film may be bonded together.

The amount applied of the adhesive may be typically within a range from 0.05 to 10.0 g/m². From the viewpoint of the adhesive strength, the amount applied is preferably at least 0.05 g/m². From the viewpoint of ink passability and the viewpoint of achieving favorable perforations, the amount applied is preferably not more than 10.0 g/m².

There are no particular limitations on the method used for irradiating the layered body L with active energy rays.

Examples of the active energy rays include ultraviolet rays, X-rays, electron beams, and visible light, and among them, ultraviolet rays are preferable.

In the active energy ray irradiation step, for example, the layered body L may be irradiated with ultraviolet rays using a light source for irradiating ultraviolet rays. Examples of the light source for irradiating ultraviolet rays include UV-LEDs, high-pressure mercury lamps, metal halide lamps, and xenon lamps, capable of emitting ultraviolet rays.

The active energy rays may be irradiated, for example, from the screen printing mesh side of the layered body. The active energy rays may be irradiated, for example, from the thermoplastic resin film side of the layered body L.

The method for producing the heat-sensitive screen master may include one or more other steps in addition to the active energy ray irradiation step.

The method for producing the heat-sensitive screen master may include a step of producing the layered body L before the active energy ray irradiation step.

The method for producing the heat-sensitive screen master preferably includes, for example, after the active energy ray irradiation step, a step of winding up the obtained layered body in a roll form.

The method for producing the heat-sensitive screen master preferably includes, for example, a drying step for drying the obtained layered body after the active energy ray irradiation step. The drying temperature in the drying step is preferably from 30° C. to 60° C. (for example, 50° C.). The drying time is preferably 1 to 5 days (for example, 3 days). The humidity may be controlled, and the humidity may be from 70 to 90% (for example, RH 80%).

The drying may be performed in multiple steps under different conditions. For example, the first stage drying may be performed at a temperature of from 40 to 70° C. (for example, 60° C.), and then the second stage drying may be performed, for example, in a humid state (for example, RH of from 70 to 90%). In a humid state, the temperature may be from about 25 to about 35° C. The drying time of the first stage and the drying time of the second stage are not particularly limited and may be from about 1 to about 2 days, respectively.

The method for producing the heat-sensitive screen master may include, for example, after the active energy ray irradiation step, a step of winding up the obtained layered body into a roll, and a drying step, in this order.

The heat-sensitive screen master can undergo platemaking using a thermal platemaking device that uses a thermal head, and the thus obtained plate can be used as a plate for stencil printing.

Using the plate obtained by subjecting this heat-sensitive screen master to platemaking, stencil printing can be performed. Examples of inks that may be used for the printing include inks which can be used for stencil printing such as screen printing. Examples of such inks include oil-based inks, solvent inks, aqueous inks, water-in-oil (W/I) emulsion inks, oil-in-water (O/W) emulsion inks, and plastisol inks.

### EXAMPLES

The present invention is described below in detail based on a series of examples and comparative examples, but the present invention is not limited to solely to these examples. Unless specifically stated otherwise, “%” refers to “% by mass”. Blend amounts of the materials in the tables also represent “% by mass” values.

### 1. Adhesive

The compositions of adhesives of various examples and comparative examples are shown in Tables 1 and 2. The blend amount of each material in Tables 1 and 2 indicates a % by mass value. The adhesives of the various examples and comparative examples were prepared for use by mixing the materials shown in Tables 1 and 2 in the proportions shown in Tables 1 and 2. In Table 1, “Ex.” indicates “Example”.

Details of each of the materials listed in Tables 1 and 2 are shown below.

TAKELAC A-666: a urethane prepolymer (manufactured by Mitsui Chemicals, Inc.)

EXCENOL 750ED: a polyether polyol (manufactured by AGC Group)

DURANATE TPA-100: an isocyanurate-modified product of hexamethylene diisocyanate (HDI) (manufactured by Asahi Kasei Corporation) (in Tables 1 and 2, “TPA-100”)

UA-306H: urethane (meth)acrylate (a penthaerythritol triacrylate hexamethylene diisocyanate urethane prepolymer) (manufactured by Kyoeisha Chemical Co., Ltd.)

EPOXY ESTER 80 MFA: epoxy (meth)acrylate (EPOLITE 80MF (glycerol diglycidyl ether) acrylic acid adduct) (manufactured by Kyoeisha Chemical Co., Ltd.)

OMNIRAD 907: a photopolymerization initiator (2-methyl-1-[4-(methylthio) phenyl]-2-morpholinopropane-1-one) (IGM Resin)

### 2. Preparation of Heat-Sensitive Screen Master

Using a laminator, a polyester screen printing mesh having a thickness of 73 μm (mesh count: #200, wire diameter: 48 μm) (“79/200-48” manufactured by Nippon Tokushu Fabric Inc.) and a biaxially stretched polyester film having a thickness of 2 μm were bonded with the above adhesive to obtain a layered body. The adhesive was applied using a roll coater at an applied amount of 3.0 g/m².

The layered body was irradiated with ultraviolet rays, and the obtained layered body was wound up, dried for one day in a constant-temperature chamber at 60° C., and then dried for one day in a constant-temperature chamber at 30° C. and 80% RH. Accordingly, a heat-sensitive screen master was obtained.

### 3. Evaluation

Using the adhesives or the heat-sensitive screen masters of the examples and comparative examples obtained as described above, the number of wrinkles generated, the adhesive strength, and the solvent resistance were evaluated as follows. The results are shown in Tables 1 and 2.

### <Number of Wrinkles Generated>

The number of wrinkles generated in an area of 1 m×100 m of the heat-sensitive screen master of each example and comparative example was counted and evaluated based on the following evaluation criteria.

S: the number of wrinkles generated in the area of 1 m×100 m is 0

A: the number of wrinkles generated in the area of 1 m×100 m is from 1 to 4

B: the number of wrinkles generated in the area of 1 m×100 m is from 5 to 10

C: the number of wrinkles generated in the area of 1 m×100 m is greater than 10

### <Adhesive Strength>

The adhesive strength was evaluated using the heat-sensitive screen master of each example and comparative example. Specifically, an adhesive tape was affixed to the thermoplastic resin film side of the heat-sensitive screen master, and following detachment of the end portions of the screen printing mesh and the thermoplastic resin film, the laminate peeling strength was measured by STROGRAPH VGS05-D manufactured by Toyo Seiki Seisaku-sho, Ltd., and the obtained result was evaluated based on the following evaluation criteria.

S: 120 gf/25 mm or greater

A: 100 gf/25 mm or greater but less than 120 gf/25 mm

B: 60 gf/25 mm or greater but less than 100 gf/25 mm

C: less than 60 gf/25 mm

### <Solvent Resistance>

The solvent resistance was evaluated using the adhesive of each examples and comparative example. Specifically, a bar coater was used to apply the adhesive to a PET film having a thickness of 125 μm with a coating thickness of 5 μm, and following drying for one day in a constant-temperature chamber at 60° C., drying was continued for one day in a constant-temperature chamber at 30° C. and 80% RH.

The thus obtained coating film was immersed in toluene for 15 minutes, the ratio of change in weight of the coating film from before to after immersion in toluene was measured, and the absolute value of the ratio of change in weight was evaluated based on the following evaluation criteria.

S: 0.5% or less

A: greater than 0.5% but not more than 2.0%

B: greater than 2.0% but not more than 5.0%

C: greater than 5.0%

TABLE 1

| (% by mass) | | Ex. 1 | Ex. 2 | Ex. 3 | Ex. 4 | Ex. 5 | Ex. 6 | Ex. 7 |
|---|---|---|---|---|---|---|---|---|
| Component A | TAKELAC | 19.00 | 18.00 | 16.00 | | 16.00 | 40.00 | 68.00 |
| | A-666 | | | | | | | |
| | EXCENOL | | | | 16.00 | | | |
| | 750ED | | | | | | | |
| Component B | TPA-100 | 76.00 | 72.00 | 64.00 | 64.00 | 64.00 | 40.00 | 12.00 |
| Component C | UA-306H | 4.85 | 9.70 | 19.40 | 19.40 | | 19.40 | 19.40 |
| | EPOXY | | | | | 19.40 | | |
| | ESTER | | | | | | | |
| | 80 MFA | | | | | | | |
| Component D | OMNIRAD | 0.15 | 0.30 | 0.60 | 0.60 | 0.60 | 0.60 | 0.60 |
| | 907 | | | | | | | |

| | | | | | | | |
|---|---|---|---|---|---|---|---|
| Total (% by mass) | 100.00 | 100.00 | 100.00 | 100.00 | 100.00 | 100.00 | 100.00 |
| Component A:Component B | 20:80 | 20:80 | 20:80 | 20:80 | 20:80 | 50:50 | 85:15 |
| (mass ratio) | | | | | | | |
| Number of wrinkles | A | S | S | S | S | A | B |
| generated | | | | | | | |
| Adhesive strength | A | S | A | A | A | A | S |
| Solvent resistance | S | S | A | A | A | A | B |

TABLE 2
Table 2

| | | Compara- | Compara- | Compara- |
|---|---|---|---|---|
| | | tive | tive | tive |
| (% by mass) | | Example 1 | Example 2 | Example 3 |
| Component A | TAKELAC A-666 | 85.00 | 20.00 | |
| | EXCENOL 750ED | | | |
| Component B | TPA-100 | 15.00 | 80.00 | |
| Component C | UA-306H | | | 97.00 |
| | EPOXY ESTER | | | |
| | 80 MFA | | | |
| Component D | OMNIRAD 907 | | | 3.00 |

| | | | |
|---|---|---|---|
| Total (% by mass) | 100.00 | 100.00 | 100.00 |
| Component A:Component B | 85:15 | 20:80 | — |
| (mass ratio) | | | |
| Number of wrinkles generated | C | C | S |
| Adhesion strength | A | B | C |
| Solvent resistance | C | S | A |

As shown in the tables, Examples 1 to 7 exhibited excellent results for both the number of wrinkles generated and the adhesive strength.

In contrast, in Comparative Examples 1 and 2, in which neither component C nor component D was contained in the adhesive, the number of wrinkles generated was large. In Comparative Example 3 in which neither component Anor component B was contained in the adhesive, the adhesive strength was inferior.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An adhesive comprising at least one selected from the group consisting of a urethane prepolymer and a polyol, a polyisocyanate, a polymerizable (meth)acrylate compound, and a photopolymerization initiator.

2. The adhesive according to claim 1, wherein a mass ratio (A:B) between the at least one (A) selected from the group consisting of a urethane prepolymer and a polyol, and the polyisocyanate (B) is within a range from 90:10 to 5:95.

3. The adhesive according to claim 2, wherein the mass ratio (A:B) between the at least one (A) selected from the group consisting of a urethane prepolymer and a polyol, and the polyisocyanate (B) is within a range from 35:65 to 5:95.

4. The adhesive according to claim 1, wherein the polyisocyanate comprises a modified product of a polyisocyanate.

5. The adhesive according to claim 4, wherein the modified product of a polyisocyanate comprises an isocyanurate-modified product of a polyisocyanate.

6. A method for producing a heat-sensitive screen master, the method comprising irradiating a layered body comprising a screen printing mesh, an adhesive layer comprising the adhesive according to claim 1, and a thermoplastic resin film in this order, with active energy rays.

7. The method for producing a heat-sensitive screen master according to claim 6, wherein, in the adhesive, a mass ratio (A:B) between the at least one (A) selected from the group consisting of a urethane prepolymer and a polyol, and the polyisocyanate (B) is within a range from 90:10 to 5:95.

8. The method for producing a heat-sensitive screen master according to claim 7, wherein, in the adhesive, the mass ratio (A:B) between the at least one (A) selected from the group consisting of a urethane prepolymer and a polyol, and the polyisocyanate (B) is within a range from 35:65 to 5:95.

9. The method for producing a heat-sensitive screen master according to claim 6, wherein, in the adhesive, the polyisocyanate comprises a modified product of a polyisocyanate.

10. The method for producing a heat-sensitive screen master according to claim 9, wherein, in the adhesive, the modified product of a polyisocyanate comprises an isocyanurate-modified product of a polyisocyanate.

11. A heat-sensitive screen master comprising a screen printing mesh, a layer formed using the adhesive according to claim 1, and a thermoplastic resin film.

12. The heat-sensitive screen master according to claim 11, wherein, in the adhesive, a mass ratio (A:B) between the at least one (A) selected from the group consisting of a urethane prepolymer and a polyol, and the polyisocyanate (B) is within a range from 90:10 to 5:95.

13. The heat-sensitive screen master according to claim 12, wherein, in the adhesive, the mass ratio (A:B) between the at least one (A) selected from the group consisting of a urethane prepolymer and a polyol, and the polyisocyanate (B) is within a range from 35:65 to 5:95.

14. The heat-sensitive screen master according to claim 11, wherein, in the adhesive, the polyisocyanate comprises a modified product of a polyisocyanate.

15. The heat-sensitive screen master according to claim 14, wherein, in the adhesive, the modified product of a polyisocyanate comprises an isocyanurate-modified product of a polyisocyanate.
